(19) United States
(12) Patent Application Publication
(10) Pub. No.: US 2025/0249922 A1
(43) Pub. Date: Aug. 7, 2025

(54) VEHICULAR DRIVER MONITORING SYSTEM

(71) Applicant: Magna Electronics Inc., Auburn Hills, MI (US)

(72) Inventors: Jagadish Narayan Gowda, Bengaluru (IN); Punith Chandra Y S, Karnataka (IN)

(21) Appl. No.: 19/044,659

(22) Filed: Feb. 4, 2025

Related U.S. Application Data
(60) Provisional application No. 63/549,634, filed on Feb. 5, 2024.

(51) Int. Cl. B60W 50/14; B60R 1/04; B60R 1/12; B60R 1/29; B60W 30/14; B60W 40/08; G06V 20/59; G06V 40/16

(52) U.S. Cl. CPC B60W 50/14; B60R 1/04; B60R 1/12; B60R 1/29; B60W 30/146; B60W 40/08; G06V 20/597; G06V 40/172; B60R 2001/1253; B60W 2040/0809; B60W 2040/0818; B60W 2050/143; B60W 2050/146; B60W 2420/403; B60W 2540/043; B60W 2540/223; B60W 2540/229; B60W 2556/50; G06V 2201/10

(57) ABSTRACT

A vehicular driver monitoring system includes an interior-viewing camera disposed at an interior cabin of a vehicle and viewing at least a portion of a driver of the vehicle. Image data captured by the interior-viewing camera is transferred to an electronic control unit (ECU) and is processed at the ECU. Based at least in part on processing at the ECU of image data captured by the interior-viewing camera, the vehicular driver monitoring system determines a profile associated with the driver of the vehicle. The profile includes a plurality of conditions for the driver of the vehicle. The system monitors the driver of the vehicle. Responsive to monitoring the driver of the vehicle, the vehicular driver monitoring system determines violation of a condition of the profile. Responsive to determining the violation of the condition, the vehicular driver monitoring system generates a notification.

### CROSS REFERENCE TO RELATED APPLICATION

The present application claims the filing benefits of U.S. provisional application Ser. No. 63/549,634, filed Feb. 5, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driver monitoring system includes an interior-viewing camera disposed within an interior cabin of a vehicle equipped with the vehicular driver monitoring system. The interior-viewing camera views at least a portion of a driver of the vehicle within the interior cabin of the vehicle. The interior-viewing camera is operable to capture image data. The interior-viewing camera includes an imaging array having at least one million photosensor elements arranged in rows and columns. An electronic control unit (ECU) includes electronic circuitry and associated software, and the electronic circuitry includes a data processor. Image data captured by the interior-viewing camera is transferred to the ECU and is processed at the ECU. Based at least in part on processing at the ECU of image data captured by the interior-viewing camera, the vehicular driver monitoring system determines a profile associated with the driver of the vehicle, and the profile includes a plurality of conditions for the driver of the vehicle. Based at least in part on processing at the ECU of image data captured by the interior-viewing camera and determination of the profile, the vehicular driver monitoring system monitors the driver of the vehicle. Responsive to monitoring the driver of the vehicle, the vehicular driver monitoring system determines violation of a condition of the plurality of conditions of the profile of the driver of the vehicle. Responsive to determining the violation of the condition, the vehicular driver monitoring system generates a notification.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a block diagram of the vision system of FIG. 1; and

FIG. 3 is an image of a rule violation determined by the vision system of FIG. 1.

### DESCRIPTION OF THE PREFERRED EMBODIMENTS

A vehicle vision system and/or driver or driving assist system and/or alert system operates to capture images interior of the vehicle and may process the captured image data to detect objects within the vehicle, such as for a driver monitoring system. The vision system includes an image processor or image processing system that is operable to receive image data from one or more cameras and provide an output to a driver monitoring system or occupant monitoring system or other driver assistance system. Optionally, the vision system may provide a display, such as a rearview display or a top down or bird's eye or surround view display or the like.

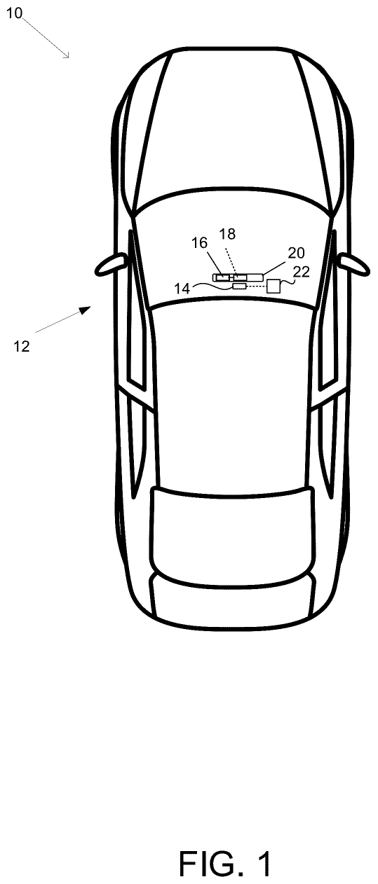

Referring now to the drawings and the illustrative embodiments depicted therein, a vehicle 10 includes an imaging system or vision system 12 that includes at least one interior viewing imaging sensor or camera, such as a driver monitoring and/or occupant monitoring camera 14 (and the system may optionally include multiple interior viewing imaging sensors or cameras), which captures images interior of the vehicle, with the camera having a lens for focusing images at or onto an imaging array or imaging plane or imager of the camera (FIG. 1). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like (although shown in FIG. 1 as being part of or incorporated in or at an interior rearview mirror assembly 20 of the vehicle, the control and/or the camera may be disposed elsewhere at or in the vehicle). The data transfer or signal communication from the camera to the ECU may comprise any suitable data or communication link, such as a vehicle network bus or the like of the equipped vehicle.

Implementations herein are directed toward a driver monitoring and/or occupant monitoring system. The system, using the interior mounted camera 14 (and optionally, one or more other cameras or other imaging sensors), monitors a driver or other occupant for rule violations and generates a notification or alert in response to determining a rule violation and/or adjusts operation of one or more systems of the vehicle (e.g., an advanced driving assistance system, an entertainment system, etc.). For example, the system monitors for an unbuckled seat belt or for the driver holding an electronic device. When the system detects that a rule is violated, the system generates a notification (e.g., to the driver or other occupant of the vehicle and/or to an owner of the vehicle).

As used herein, a rule violation may refer to any behavior or action by the driver or occupants that contravenes established safety protocols or regulations within the vehicle. A rule violation may also be referred to as a condition, a breach (e.g., a safety breach), an infraction, or an event (e.g., a safety event).

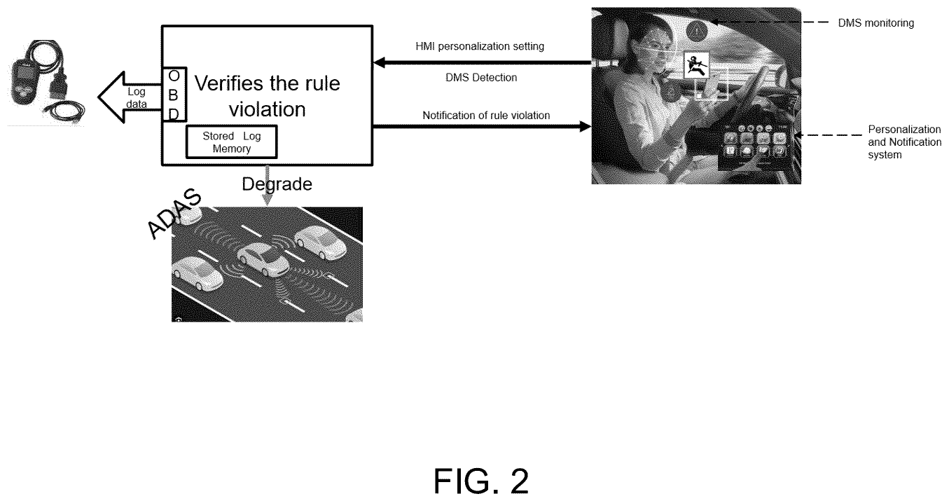

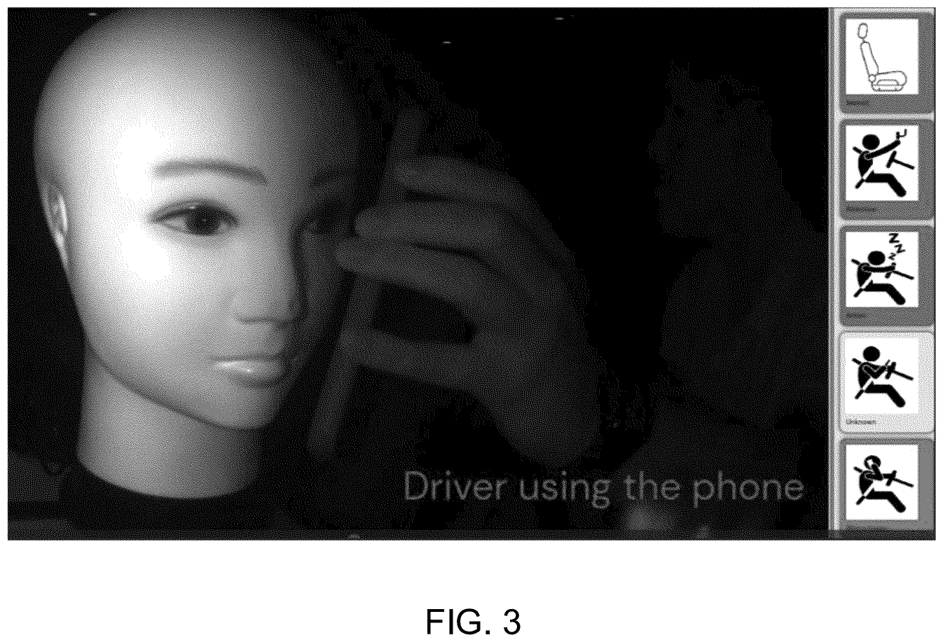

Referring now to FIGS. 2 and 3, the system monitors, via processing of image data captured by a camera (or other image sensor) of a driver monitoring system (DMS) or occupant monitoring system (OMS), for rule violations that may impact the safety of the occupants and/or the vehicle. The system includes a violation verifier module that receives sensor data from the DMS/OMS (or any other system/sensor of the vehicle) and verifies the rule violation. The violation verifier logs the violation and takes any appropriate action, such as generating a notification or adjusting/controlling other vehicle systems (FIG. 2). The system may monitor for any number of rule violations. For example, the system monitors whether seat belts are unbuckled while the vehicle is moving, whether the driver becomes distracted by a mobile device, the infotainment screen, or other object (FIG. 3), whether the driver becomes drowsy or otherwise inattentive to the road, whether the driver removes one or both hands from the wheel for a threshold period of time, etc.

The system may detect or determine rule violations using advanced image recognition and/or other sensor input. For example, the interior-mounted camera captures images of the driver and occupants, which are processed by the image processor to identify specific behaviors. The system may recognize if a seat belt is unbuckled by analyzing the position and state of the seat belt through image data. As another example, the system may detect if the driver is distracted by monitoring the driver's eye movements and head position. When the driver's eyes are off the road for greater than a threshold period of time, the system may flag this as a rule violation. Similarly, the system may determine if the driver is drowsy by tracking eyelid movements, blink rates, respiratory patterns, etc.

The rules may be tailored or personalized for the current driver. For example, each driver is associated with a profile. The profile tracks or maintains the rules to monitor for that particular driver. The profile may be stored at the vehicle, at a mobile electronic device of an occupant of the vehicle and in communication with the vehicle (e.g., a smartphone), and/or at a remote server accessed via wireless communication (e.g., over the Internet using cellular communication networks). The profile may personalize which rules to monitor, the thresholds for determining when a rule is violated, who is notified in response to a violation, and what other actions the system performs in response to a violation. For example, one profile may indicate that a rule violation results in a visible notification displayed on a screen of the vehicle and/or an audible notification played over speakers of the vehicle, while a different profile may indicate that a rule violation results in an owner of the vehicle receiving a notification at a mobile device (e.g., when the profile is associated with a young or inexperienced driver or with a temporary driver like a chauffeur or valet), while yet a different profile may indicate that a rule violation results in disabling the sound of an entertainment system. The profile may indicate any combination of actions in response to violation (e.g., multiple notifications and/or system or feature adjustments).

The profiles may be configured or modified by users of the vehicle. In some examples, a profile may only be modified by an owner of the vehicle (e.g., an owner of a vehicle establishing a profile for a young driver of the vehicle). The system may automatically recognize a driver and select the appropriate profile via facial recognition technologies and/or device identification technologies (i.e., recognizing a mobile device or a key carried by the driver) and/or a password, etc.

In addition to or alternative to generating a notification, the system may control one or more aspects of the vehicle. For example, the system may respond to determination of a rule violation by decreasing the speed of the vehicle, imposing a maximum speed of the vehicle, imposing a maximum acceleration of the vehicle, reducing a volume of the entertainment system, disabling one or more autonomous or semi-autonomous features, etc. The system may generate a notification (e.g., a visual notification displayed at an interior display of the vehicle, an audible notification played via a speaker of the vehicle, etc.) alerting the occupants of the vehicle of the adjusted or controlled aspect of the vehicle. For example, the system may generate a notification indicating that the volume of the infotainment system is limited until the violation is resolved.

The system may log each violation in internal memory and/or at remote memory (i.e., accessed via wireless communication). The log may include additional metadata (e.g., a timestamp or data from other sensors such as location data captured by a GPS sensor) with each violation. One or more frames of image data captured by the camera may be logged with each violation. For example, when the violation is caused by an inattentive driver, the log may include one or more images of the driver while inattentive. The log data, in some examples, may be accessed via an OBD II connector or other diagnostic tool. Additionally or alternatively, the log data may be provided (automatically or via a request) to an owner or other designated individual via wired or wireless communication networks. Optionally, the violations and/or a driving pattern extracted from the system may be analyzed (e.g., by insurance companies) to determine a safety or experience or quality of the driver (e.g., to determine premiums or the like).

The system may leverage a DMS to detect or determine a face or head of a driver of the vehicle and to detect the driver's hands or presence of a mobile device. The system may include inputs from other sensors, such as a seat belt sensor to determine whether the seat belt is fastened. The system may process image data captured by the camera to determine whether the seat belt is properly worn. The system may generate the notifications for a human-machine interface (HMI) of the vehicle, such as an infotainment display, a head up display, a dashboard, or the like. The notifications may be visual (e.g., via one or more displays), audible (e.g., via one or more speakers), or haptic (e.g., via vibrations in the seat or steering wheel).

The response of the system may be fully configurable. For example, in response to determination of a rule violation, the system may generate a notification for the driver of the vehicle, the system may generate a notification for an owner of the vehicle (or other designated individual(s)), the system may log the rule violation at a database, or any combination of the three. Creation or editing of profiles may be restricted (e.g., via a password).

Thus, implementations herein include a driver monitoring system that detects one or more rule violations (e.g., hands off the steering wheel, holding an electronic device, etc.) for a driver of a vehicle. The system helps avoid hazardous events due to irresponsible driving by the driver of the vehicle. The system may provide additional driver safety and better awareness of vehicle usage.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024, and/or U.S. provisional application Ser. No. 63/641,574, filed May 2, 2024, and/or International Publication No. WO 2023/220222, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driver monitoring system, the vehicular driver monitoring system comprising:
an interior-viewing camera disposed within an interior cabin of a vehicle equipped with the vehicular driver monitoring system, the interior-viewing camera viewing at least a portion of a driver of the vehicle within the interior cabin of the vehicle, wherein the interior-viewing camera is operable to capture image data;
wherein the interior-viewing camera comprises an imaging array having at least one million photosensor elements arranged in rows and columns;
an electronic control unit (ECU), the ECU comprising electronic circuitry and associated software, wherein the electronic circuitry comprises a data processor;
wherein image data captured by the interior-viewing camera is transferred to the ECU and is processed at the ECU;
wherein, based at least in part on processing at the ECU of image data captured by the interior-viewing camera, the vehicular driver monitoring system determines a profile associated with the driver of the vehicle, and wherein the profile includes a plurality of conditions for the driver of the vehicle;
wherein, based at least in part on processing at the ECU of image data captured by the interior-viewing camera and determination of the profile, the vehicular driver monitoring system monitors the driver of the vehicle;
wherein, responsive to monitoring the driver of the vehicle, the vehicular driver monitoring system determines violation of a condition of the plurality of conditions of the profile of the driver of the vehicle; and
wherein, responsive to determining the violation of the condition, the vehicular driver monitoring system generates a notification.

2. The vehicular driver monitoring system of claim 1, wherein the vehicular driver monitoring system provides the notification to the driver of the vehicle.

3. The vehicular driver monitoring system of claim 1, wherein the vehicular driver monitoring system provides the notification to an owner of the vehicle via wireless communication.

4. The vehicular driver monitoring system of claim 1, wherein the vehicular driver monitoring system logs the violation at a database.

5. The vehicular driver monitoring system of claim 1, wherein the vehicular driver monitoring system includes metadata with the violation, and wherein the metadata comprises at least one selected from the group consisting of (i) a timestamp indicating when the violation occurred, (ii) a frame of image data captured by the interior-viewing camera, and (iii) location data captured by a GPS sensor.

6. The vehicular driver monitoring system of claim 1, wherein an owner of the vehicle establishes each condition of the plurality of the conditions of the profile.

7. The vehicular driver monitoring system of claim 1, wherein the vehicular driver monitoring system identifies the driver of the vehicle using facial recognition techniques and determines the profile associated with the identified driver of the vehicle.

8. The vehicular driver monitoring system of claim 1, wherein determination of the violation of the condition is based on at least one selected from the group consisting of (i) location of hands of the driver, (ii) use of a mobile device by the driver, and (iii) a seat belt of the driver.

9. The vehicular driver monitoring system of claim 1, wherein, responsive to determining the violation of the condition, the vehicular driver monitoring system reduces a speed of the vehicle.

10. The vehicular driver monitoring system of claim 1, wherein, responsive to determining the violation of the condition, the vehicular driver monitoring system degrades functionality of an advanced driver assistance system.

11. A vehicular driver monitoring system, the vehicular driver monitoring system comprising:
an interior-viewing camera disposed within an interior cabin of a vehicle equipped with the vehicular driver monitoring system, the interior-viewing camera viewing at least a portion of a driver of the vehicle within the interior cabin of the vehicle, wherein the interior-viewing camera is operable to capture image data;
wherein the interior-viewing camera comprises an imaging array having at least one million photosensor elements arranged in rows and columns;
an electronic control unit (ECU), the ECU comprising electronic circuitry and associated software, wherein the electronic circuitry comprises a data processor;
wherein image data captured by the interior-viewing camera is transferred to the ECU and is processed at the ECU;
wherein, based at least in part on processing at the ECU of image data captured by the interior-viewing camera, the vehicular driver monitoring system determines a profile associated with the driver of the vehicle, and wherein the profile includes a plurality of conditions for the driver of the vehicle, and wherein an owner of the vehicle establishes each condition of the plurality of the conditions of the profile;
wherein, based at least in part on processing at the ECU of image data captured by the interior-viewing camera and determination of the profile, the vehicular driver monitoring system monitors the driver of the vehicle;
wherein, responsive to monitoring the driver of the vehicle, the vehicular driver monitoring system determines violation of a condition of the plurality of conditions of the profile of the driver of the vehicle, and wherein determination of the violation of the condition is based on at least one selected from the group consisting of (i) location of hands of the driver, (ii) use of a mobile device by the driver, and (iii) a seat belt of the driver; and
wherein, responsive to determining the violation of the condition, the vehicular driver monitoring system generates a notification.

12. The vehicular driver monitoring system of claim 11, wherein the vehicular driver monitoring system identifies the driver of the vehicle using facial recognition techniques and determines the profile associated with the identified driver of the vehicle.

13. The vehicular driver monitoring system of claim 11, wherein, responsive to determining the violation of the condition, the vehicular driver monitoring system reduces a speed of the vehicle.

14. The vehicular driver monitoring system of claim 11, wherein, responsive to determining the violation of the condition, the vehicular driver monitoring system degrades functionality of an advanced driver assistance system.

15. The vehicular driver monitoring system of claim 11, wherein the vehicular driver monitoring system provides the notification to the driver of the vehicle.

16. A vehicular driver monitoring system, the vehicular driver monitoring system comprising:
an interior-viewing camera disposed within an interior cabin of a vehicle equipped with the vehicular driver monitoring system, the interior-viewing camera viewing at least a portion of a driver of the vehicle within the interior cabin of the vehicle, wherein the interior-viewing camera is operable to capture image data;
wherein the interior-viewing camera comprises an imaging array having at least one million photosensor elements arranged in rows and columns;
an electronic control unit (ECU), the ECU comprising electronic circuitry and associated software, wherein the electronic circuitry comprises a data processor;
wherein image data captured by the interior-viewing camera is transferred to the ECU and is processed at the ECU;
wherein, based at least in part on processing at the ECU of image data captured by the interior-viewing camera, the vehicular driver monitoring system determines a profile associated with the driver of the vehicle, and wherein the profile includes a plurality of conditions for the driver of the vehicle;
wherein, based at least in part on processing at the ECU of image data captured by the interior-viewing camera and determination of the profile, the vehicular driver monitoring system monitors the driver of the vehicle;
wherein, responsive to monitoring the driver of the vehicle, the vehicular driver monitoring system determines violation of a condition of the plurality of conditions of the profile of the driver of the vehicle;
wherein, responsive to determining the violation of the condition, the vehicular driver monitoring system generates a notification;
wherein the vehicular driver monitoring system logs the violation at a database; and
wherein the vehicular driver monitoring system logs metadata with the violation, and wherein the metadata comprises at least one selected from the group consisting of (i) a timestamp indicating when the violation occurred, (ii) a frame of image data captured by the interior-viewing camera, and (iii) location data captured by a GPS sensor.

17. The vehicular driver monitoring system of claim 16, wherein the vehicular driver monitoring system provides the notification to the driver of the vehicle.

18. The vehicular driver monitoring system of claim 16, wherein the vehicular driver monitoring system provides the notification to an owner of the vehicle via wireless communication.

19. The vehicular driver monitoring system of claim 16, wherein, responsive to determining the violation of the condition, the vehicular driver monitoring system reduces a speed of the vehicle.

20. The vehicular driver monitoring system of claim 16, wherein, responsive to determining the violation of the condition, the vehicular driver monitoring system degrades functionality of an advanced driver assistance system.
